(19) United States
(12) Patent Application Publication
(10) Pub. No.: US 2007/0053217 A1
(43) Pub. Date: Mar. 8, 2007

(54) CONVERTER FOR AUTOMOTIVE USE

(75) Inventor: Yann Darroman, Barcelona (ES)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/162,249

(22) Filed: Sep. 2, 2005

(51) Int. Cl. H02M 3/06

(52) U.S. Cl. 363/62

(57) ABSTRACT

A step down voltage converter for automotive electrical power supply networks reduces voltage down at least one order, for example, 42V down to 3V or lower, for the supply of microcontrollers and semiconductors. A preferred embodiment employs a tapped-inductor and three discrete components. The use of tapped-inductor is well-known and the design gives an extra-degree of freedom by the insertion of the winding ratio of the tapped-inductor into the transfer function of the Watkins-Johnson converter. It also permits the duty cycle to be adjusted to a value at which the efficiency of the converter is improved. The converter can be slightly modified and used as a multiple output converter while employing few components, diminishing the weight, size, cost and complexity of a system.

### BACKGROUND OF THE INVENTION

1. Field of the Invention

A step down voltage converter for automotive electrical power supply networks reduces voltage down at least one order, for example, from 42V down to 3V or lower, for the supply of microcontrollers and semiconductors.

2. Background Art

In the aim of complying with customer's requirements, automotive electrical systems have gradually become more complex and difficult to manage. Growing customer demands for quality improvement, security, comfort and fuel saving have drastically increased the number of power-hungry electronics loads in the vehicle from 800 W to several kW. Modifications in vehicle electrical systems are made according to the dynamics of the rest of the society sectors, i.e., encouraging the substitution of the passive components by other integrated electronics and active circuits. This phenomenon has also drastically increased the number of electronic modules in the vehicles. The increasing number of electrical and electronics modules made soar the current consumption. Therefore, the common 14V power network may be insufficient to comply with this soaring power consumption. That problem has been even more emphasized with the new technologies like X-by-wire, which need some peaks of current of hundreds of amps. Several solutions sought were the use of two or more batteries, distributing an additional battery in each of the critical modules, and the creation of a new higher voltage power network.

### BRIEF DESCRIPTION OF THE DRAWINGS

The present invention will be more clearly understood by reference to the following detailed description of the preferred embodiment when read in conjunction with the accompanying drawing, in which like reference characters refer to like parts throughout the views, and in which:

FIG. 1 is a schematic diagram of a prior art cascading two dc-dc buck converters;

FIG. 2 is a schematic view of a prior art quadratic buck converter;

FIG. 3 is a schematic view of a prior art synchronous rectifier buck converter;

FIG. 4 is a schematic diagram of a prior art standard forward buck converter;

FIGS. 5a-5d are a series of schematic diagrams comparing a standard converter with tapped-inductor converters;

FIG. 6 is a graphic representation of buck converter transfer ratio for a tapped-inductor converter in a continuous conduction mode for use in automotive applications of the present invention;

FIG. 7 is a schematic representation of a multiple output, tapped-inductor converter used in automotive applications according to the present invention;

FIG. 8 is a schematic diagram of a tapped-inductor converter for operation in a high voltage electrical power supply system for an automobile in accordance with the present invention;

FIG. 9 is a schematic diagram with arrows demonstrating parasitic leakage energy in a tapped-inductor converter of an automotive electrical power supply circuit according to the invention;

FIGS. 10a-10c are a series of graphical representations displaying the voltage across the main switch for different kinds of snubbers employed with the tapped-inductor converter in an automotive electrical power supply system according to the present invention;

FIGS. 11a-11c are a series of graphical representations of the current through the synchronous rectifiers for different snubbers for the tapped-inductor converter of an automotive electrical power supply electrical system;

FIGS. 12a-12c are a series of graphical representations of the current through the main switch for different snubbers for a tapped-inductor converter in an automotive electrical power supply system according to the invention;

FIG. 13 is a schematic diagram of a tapped-inductor converter combined with an RC snubber in an automotive electrical power supply system according to the invention;

FIG. 14 is a schematic diagram of a tapped-inductor converter combined with an LC snubber in an automotive electrical power supply system according to the invention; and

FIG. 15 is a graphic representation of transfer ratio versus duty cycle for different tapped-inductor converters for an automotive electrical power supply system according to the invention.

### DETAILED DESCRIPTION OF THE PREFERRED EMBODIMENT(S)

The supply of semiconductors, microprocessors or other loads in a passenger or commercial vehicle often requires much lower power/lower voltage. A proposed 42V supply system may need to be stepped down about an order of magnitude, for example, as low as 5V and even as little as 3V or less. When such a low conversion ratio as Vₒᵤₜ/Vᵢₙ=3/42 is required, the duty cycle δ must be very low to achieve such a transfer ratio. The efficiency of a classical buck converter may be considered unacceptably low according to the inventor, leading to poor utilization of passive components and poor current waveform form factors that may not be tolerated in an automotive electrical power supply network. Standard buck converters may be considered only when not too large a potential difference separates the output voltage from the input voltage (i.e., when the duty cycle δ is high and typically over 50%.

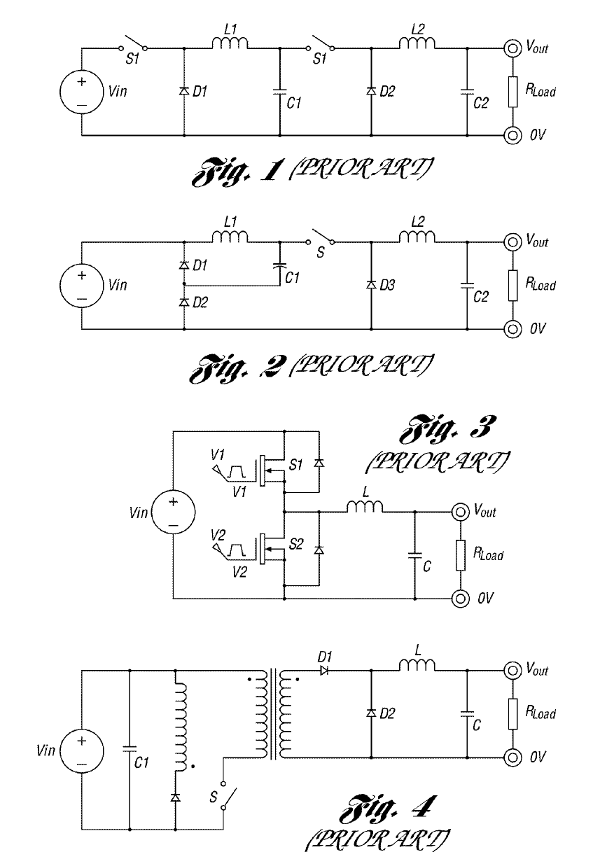

In order to improve the efficiency and power factor, the duty cycle needs increasing. The conversion ratio may be extended significantly by cascading two dc-dc buck converters. The two buck converter arrangement is illustrated in FIG. 1. For the same duty cycle δ a larger conversion ratio is obtained than for the classical buck (with Vₒᵤₜ/Vᵢₙ=δ²). However, such applications require twice as many components as a basic buck converter, which is very costly and difficult to manage.

A proposed improvement would be the use of quadratic buck converters (FIG. 2), which present a higher voltage ratio. In fact, these converters have the same conversion ratio as two cascaded buck dc-dc converters, with only one transistor switch. They are called quadratic converters because they square the standard dc-dc converter voltage ratios. This leads to easier control and management of the converter. Moreover, compared to a classical buck, quadratic buck converter yields a much lower limit on the minimum attainable conversion ratio.

Even though the quadratic buck converters utilize a single transistor switch, the number of components is still higher than that of the basic buck converter. Hence the applications of the quadratic converters are only tolerable where conventional, single stage converters are inadequate, for example, in particular to high frequency applications, where the specified range of input voltages and the specified range of output voltages call for an extremely large range of conversion ratios.

Synchronous rectification improves the efficiency of the buck converter. The technique employed may be to substitute the classical freewheeling diode by an N-channel MOSFET (S2) in FIG. 3. Both transistor switches are controlled by two signals v₁ and v₂ one of which is the inverse of the other. The improvement is achieved for duty cycles over 50%, but not below that value. Smaller duty cycles cause losses in the inductor as well as larger inductor ripple currents, which increase conduction losses and switching losses in the MOSFETs. Another problem for the synchronous rectifier buck converter working at low duty cycle (<50%), may be the asymmetric transient response that occurs due to the great difference between the rate of rise and the rate of fall of the inductor current. During the turn-on period of the top switch, the rate of rise in the inductor current is given by:

$$\frac{ⅆ i}{ⅆ t} ( rise ) = \frac{( {V}_{i n} - {V}_{out} )}{L} \qquad ( 1 )$$

The rate of fall in the inductor current during the freewheeling period is given by:

$$\frac{ⅆ i}{ⅆ t} ( fall ) = \frac{{V}_{out}}{L} \qquad ( 2 )$$

Since the rate of fall is the slowest, this value limits the transient response of the synchronous rectifier buck converter.

Another solution may consist of stepping down the input voltage and isolating it from the load via a transformer (FIG. 4). The winding ratio of the transformer m yields high step-down ratios for the dc-dc buck converter.

Nevertheless, this solution has drawbacks. The circuit is made more expensive, heavier, bulkier and more complex by the presence of the transformer since three windings are needed. In addition, during the recovery period, no power transfer is implemented.

The present invention overcomes the above discussed disadvantages as embodiments are selected to reduce the increased cost, weight, size, complexity and energy losses associated with the use of transformers in high conversion ratio dc-dc converters. Preferably, as shown in the embodiments of FIGS. 7-15, the converter need not use any transformer and avoids the problems associated with cascading several dc-dc converters.

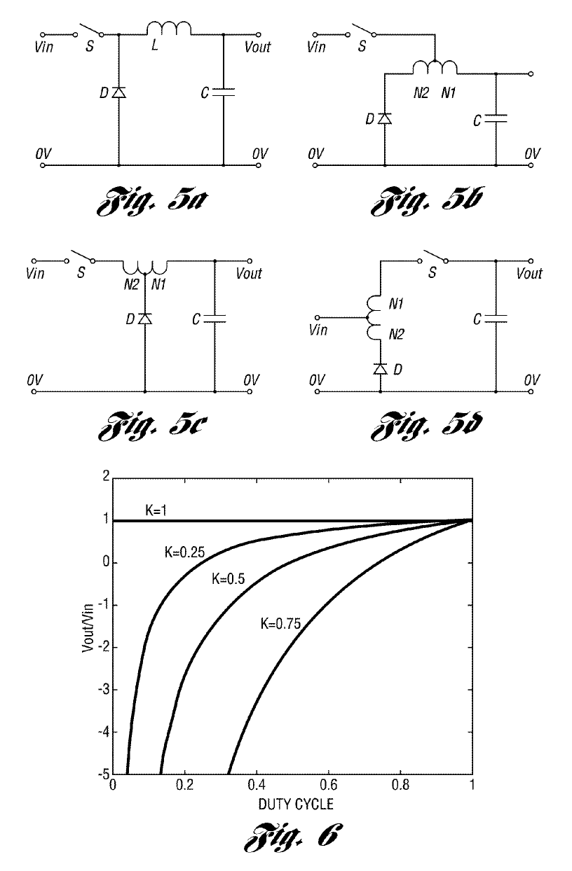

A preferred embodiment uses the Watkins-Johnson converter (or rail-to-tap buck converter) as suitable choice when designing 42V/3V converters in the automotive field. The Watkins-Johnson converter as shown in FIG. 5d, was formerly used as the power amplifier in communication satellites. The desirable characteristics may not be readily adapted in the automotive power system, but this converter needs only a low number of components to be employed and presents a high duty cycle for small output conversion ratios, such as 42V to 3V.

The converter in FIGS. 7 and 8 are particular cases of a tapped inductor dc-dc buck converter topology. The invention embodiments may also provide an advantage that the duty cycle of the basic buck converter can be extended by the substitution of the standard coil shown in FIG. 5a by a tapped inductor 20. It will be shown that three different buck converters, including Watkins-Johnson converter, are obtained by component rearrangement. Characteristics of the Watkins-Johnson converter may be adapted to replace conventional topologies when applied to automotive 42V/3V power conversion, including multiple output capabilities, as discussed below.

The simplest method of extending the duty cycle range in classical dc-dc converters consists of replacing the inductor L of the three basic dc-dc converters by a tapped inductor 20 (FIG. 5d), which is a transformer in which part of one winding is common to both the primary and the secondary circuits associated with the winding. Compared to an auto-transformer, the tapped-inductor may be designed with an air-gap and shall store energy.

Among all the existing methods of obtaining a wide conversion ratio, the advantage of tapped-inductor is that it only involves a modification of the original converters. Substituting the coil in the standard buck converter by a tapped-inductor leads to the creation of three new kinds of buck converters called, switch-to-tap, diode-to-tap or rail-to-tap (Watkins Johnson) buck converters according to the type of components connected to the tap of the inductor. FIGS. 5a-5d represent the four different buck converters.

These four different buck converters exhibit different conversion ratios in continuous and discontinuous conduction modes. However, the continuous conduction mode may be considered preferred because the latter permits a better stability in the control loop compared to the buck converter. Table 1 shows the transfer ratio of standard or buck converter and the three tapped-inductor converter topologies. An analysis of the Watkins-Johnson converter can be found in my Thesis Appendix, incorporated by reference, while analysis of switch-to-tap and diode-to-tap converters can be found in D. A. Grant and Y. Darroman “Extending the tapped-inductor DC-to-DC converter family” Electronics letters, 37, (3) pp 145-146, 2001 and Y. Darroman, “Reducing the energy consumption of battery-powered products by the use of switch mode techniques”, Ph.D thesis, University of Bristol (UK), May 2004, incorporated by reference.

In order to step down a 42V input voltage to 3V output voltage, a conversion ratio of 0.07 is needed and therefore a very low one. As mentioned before, the higher the duty cycle, the higher the efficiency for a buck converter. It can be seen that for a classical buck converter, the conversion ratio is only in terms of the duty cycle of the main transistor switch. However, for the switch-to-tap (FIG. 5b), diode-to-tap (FIG. 5c) or Watkins-Johnson (WJ) converters (FIG. 5d), in addition to the duty cycle, the conversion ratio is in terms of a winding ratio K defined as:

$$K = - \frac{N 1}{N 1 + N 2} \qquad ( 3 )$$

N1 and N2 being the number of turns either side of the tap. Basically, the winding ratio K, which has been redefined in this application to have a range between 0 and 1 like the duty cycle, can be set to a value at which device utilization is improved. Nevertheless, for economical purpose, it is more convenient to use a center-tapped-inductor for which N1 and N2 are identical and the K=0.5. Also, choosing K=0.5 make the tapped-inductor symmetrical and facilitates the assembly process since the two extremities of the component can be swapped without altering the converter behavior.

TABLE 1
Conversion ration and duty cycle values for different kinds of buck converters.

| Classical | Quadratic | Switch-to-tap | Diode-to-tap | Rail-to-tap |
|---|---|---|---|---|
| $\frac{{V}_{out}}{{V}_{in}} = δ$ | $\frac{{V}_{out}}{{V}_{in}} = {δ}^{2}$ | $\frac{{V}_{out}}{{V}_{in}} = \frac{δ}{K + δ ( 1 - K )}$ | $\frac{{V}_{out}}{{V}_{in}} = \frac{K δ}{1 + δ ( K - 1 )}$ | $\frac{{V}_{out}}{{V}_{in}} = \frac{δ - K}{δ ( 1 - K )}$ |

Therefore, a single value of duty cycle is possible for any combination of Vₒᵤₜ/Vᵢₙ. This value of duty cycle for each converter is reported to Table 2 for Vₒᵤₜ=3V, 5V and 14V.

It can be seen that for any typical automotive voltage applications that the Watkins-Johnson converter exhibits the highest duty cycle, thereby providing the highest efficiency with respect to its buck converter counterparts and with minimum number of components.

TABLE 2
Duty cycle values for different typical automotive voltage
application and with different sorts of buck converters.

| | | | Switch-to- | Diode-to- | |
|---|---|---|---|---|---|
| | Classical | Quadratic | tap | tap | Rail-to-tap |
| Vₒᵤₜ = 14 V | 0.33 | 0.57 | 0.20 | 0.50 | 0.60 |
| Vₒᵤₜ = 5 V | 0.12 | 0.34 | 0.06 | 0.23 | 0.53 |
| Vₒᵤₜ = 3 V | 0.07 | 0.26 | 0.036 | 0.14 | 0.52 |

The transfer ratio for the Watkins-Johnson converter indicates that it can buck without inversion of polarity. In this mode, it can supply a passive load (positive output voltage and positive output current). It can buck and boost with polarity inversion although in this regime, an active load is required since the output current must remain positive even though the output voltage is negative. In S. Dhar et al., “Switching Regulator with Dynamically Adjustable Supply Voltage for Low Power VLSI,” Industrial Electronics Society Annual Conference (IECON) IEEE, Vol. 3, 2001, pp. 1874-1879, the Watkins-Johnson converter is referred to as a “buck converter with desirable properties” since the output is isolated from any energy stored in the inductor.

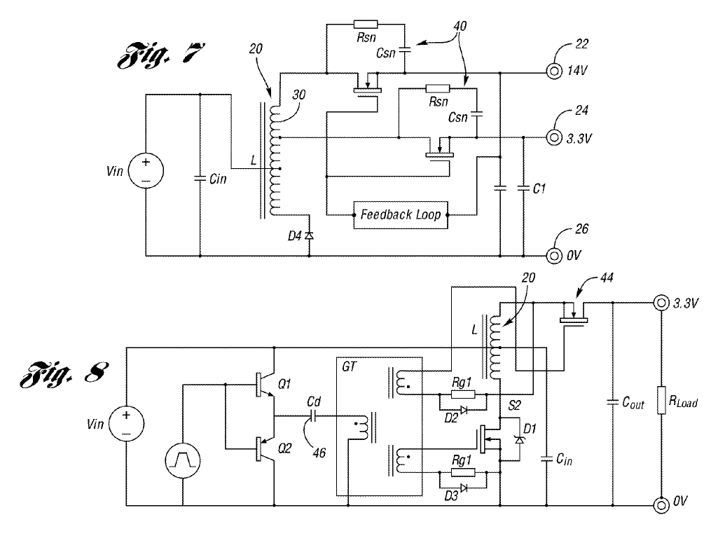

The variation of Vₒᵤₜ/Vᵢₙ with δ for various values of K is shown in FIG. 6. It can be seen that when duty cycle is in the range δ>K, the converter operates as a buck converter providing positive current with a positive output voltage to a passive load. Hence, the duty cycle δ can even be extended by increasing the winding ratio K, but at the cost of an asymmetrical tapped-inductor. When δ<K, the circuit topology requires that the current is again positive, but the output voltage is negative, a situation which is only viable with an active load. This quadrant of operation is not particularly useful and may be not preferred in automotive applications where only passive loads will be supplied by the Watkins-Johnson converter.

Table 3 lists the advantages and limitations of the Watkins-Johnson converter.

For lower converter cost and to avoid using as many converters as different voltage polarities and values, it can be economically advantageous to build a single block converter in which the most cost sensitive parts of the switched mode power supply (switching and transformer) are common to all the outputs. Hence, the Watkins-Johnson converter may be used as a multiple output converter offering output voltages of 14V and 3V from the main 42V input voltage as shown in FIG. 7. With the non-isolated multiple output Watkins-Johnson dc-dc converter, as many output voltages as required are made feasible by the use of a tapped-inductor unlike the flyback converter, whose secondary is fragmented into x windings, permitting the generation of x isolated outputs. The need for x secondary windings is quite costly due to the quantity of copper needed to comply with the different voltage requirements of a system. Since the inductor is usually the bulkiest and most expensive element in a converter, using a single winding tapped-inductor instead of many secondary windings leads to a reduction in the quantity of copper and yields a reduction in weight, size and cost of the converter.

TABLE 3
Characteristics of the Watkins-Johnson converter.

| Advantages | Limitations |
|---|---|
| Able to isolate the input from the | When used for dc-dc applications |
| output when the switch is off | (with one switch and one diode) |
| | and supplying a passive load, |
| | only the positive polarity is |
| | exploitable. |
| Grounded load | When the switch is off, the |
| | energy is given back to the |
| | source leading to high noise |
| | level. |
| Capable of producing either positive | Switch difficult to drive. |
| or negative polarity which makes it | |
| suitable for dc-to-ac applications | |
| in the case two switches are used. | |
| Transfer ratio in terms of duty | Use of a snubber and shield |
| cycle and winding ratio of the | advised. |
| tapped-inductor | |

Also, in this new non-isolated, multiple output Watkins-Johnson converter 20 (FIG. 7), the different taps 22-26 of the coil permit the duty cycle of the main transistor to be set to a desirable value, typically a value where the efficiency of the system is improved, and by tapping the coil 30 with proper turns ratio, the desired output voltage values can be obtained. Like multiple output flyback converters, the output voltages in continuous conduction mode are proportional to the respective turns ratios and closed-loop regulation of one output results in semi-regulation of all the other outputs.

Switching mode power supply is a means by which the efficiency of the voltage conversion can be improved in industrial and/or household applications. However, the switching action of dc/dc converters is a potential source of electromagnetic interference. Therefore designers of consumer products have concern that the adoption of this form of energy conversion may jeopardize the ability of their product to comply with EMC regulations.

An output filter may filter out some undesirable harmonics and lower the EMIs. The converter may also need shielding, as diagrammatically indicated at 50 in FIGS. 13 and 14, to comply with the American and European EMC standard, and may be provided in the form of a non-insulating housing over portions of the circuit in which EMI is induced. Furthermore, the cost of the shielding can be reduced as the housing may be part of a housing already existing to cover other switched-mode power management circuits within the WJ automotive electrical power supply environment.

In this converter, use of a snubber 40 and a shield 50 are preferred due to the leakage inductance of tapped-inductor and the extreme pulsating current inducing EMI (electro magnetic interference) by the current when returning to the source. Nonetheless, the current returning to the source in a WJ tapped inductor converter can be seen as an advantage since when returning to the source, the current recharges the battery and also, when the main switch is off-state, the output is isolated from any energy stored in the inductor.

In the case of the new multiple output converter of FIG. 7, several positive output voltages, which values will be less than the 42V input voltage, can be obtained by tapping the coil at suitable points. With respect to the regulation of the new converter, regulating one output leads to the auto-regulation of the other outputs with a line and load regulation of the order of 5% to 10% may be adequate for automotive power supply and many applications.

A non-isolated WJ converter has been constructed and tested (FIG. 8). The converter operates with an input voltage Vᵢₙ equal to 42V and the regulated output current of approximately 1 Amp. The switching frequency has been chosen equal to 100 kHz.

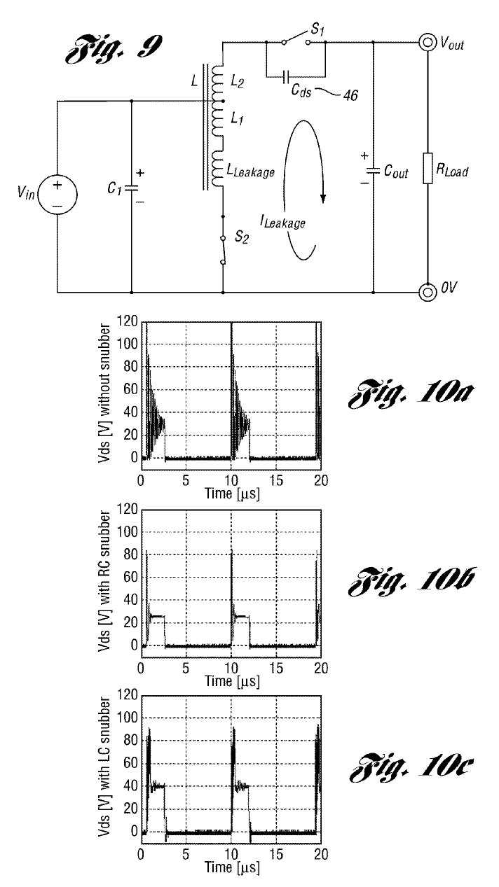

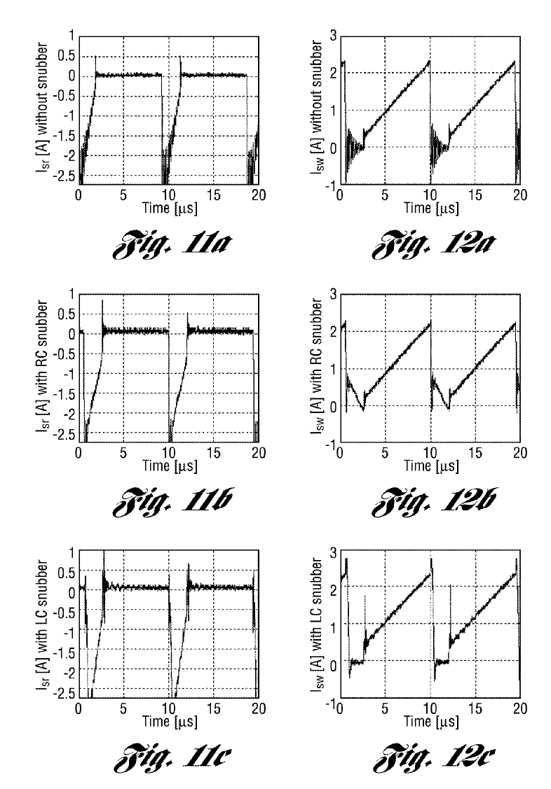

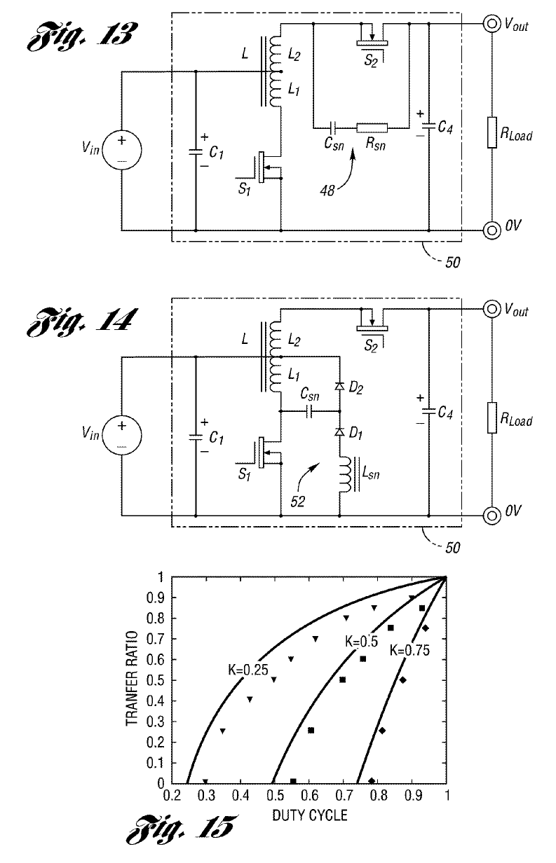

A problem associated with the use of tapped-inductor converters is the energy associated with the leakage inductance of the tapped-inductor due to imperfect coupling between windings. When the transistor switch 44 is turned “off,” the current in the leakage inductor in the primary cannot be reflected into the secondary, so it continuously goes through drain-to-source capacitor 46 of the MOSFET transistor switch 44. The energy stored in the leakage inductor will be transferred to this small capacitance, causing a large voltage spike across S1. The voltage spike, illustrated in FIG. 10, and current spikes through the main switch and synchronous rectifier represented in FIGS. 11 and 12, respectively, not only increases the switching loss, but can also destroy the switch if it exceeds the device voltage rating. Furthermore, the leakage inductor being in series with Cds 46 forms an LC tuned circuit that produces unwanted ringing and worsens the overall efficiency of the system.

An approach to combat the voltage spike due to leakage inductance is to include snubber circuits 40, which create an electrical path in order to prevent the current associated with the leakage inductance, and the parasitic inductance due to printed circuit board tracks to continue to flow into the MOSFET when the latter turns off. In the case of a dissipative snubber, energy stored in the leakage inductance is lost, unlike a non-dissipative snubber where the energy associated with the leakage inductance is recycled.

A series of tests were carried out, the first one with a circuit as shown in FIG. 9, (see 10a, 10b, 10c) a second circuit with a dissipative RC snubber 48 similar to FIG. 13 (see results 10b, 11b, 12b) and the third one with a non-dissipative LC snubber 52 similar to FIG. 14 (see 10c, 11c, 12c).

The RC snubber approach to limit stress across the semiconductor switch simplifies and reduces the expense of the circuit. Since it is a dissipative clamp, decreasing the designed clamp voltage is at the cost of the efficiency. In FIGS. 10, 11 and 12, it can be seen that the snubber alters the behavior of the converter. Some current spikes are reduced as a result of the presence of the RC clamp 48 (FIGS. 10b, 11b and 12b), but also, as mentioned previously, the over-voltage spike has been lowered and the ringing is suppressed (FIG. 10).

Compared to the RC snubber 48, the non-dissipative LC snubber 42 can be designed to achieve better converter efficiency without resulting in power losses. The clamp voltage is independent of the load unlike the RC snubber, but when employing the LC snubber 52, the current stress in the switch is generally higher. It also requires an additional winding around the core in order to reduce the current stress through the switch. FIGS. 10c, 11c and 12c represent the rail-to-tap boost converter test results with an LC lossless snubber.

Because of energy stored in leakage inductance, tapped-inductor converters can usefully employ snubbers to limit the voltage experienced by the switching devices. The overall efficiency of a system is better with an LC non-dissipative snubber, while the voltage peak across the transistor switch is more effectively reduced by an RC dissipative snubber. A Zener diode may reduce the transistor switch voltage peak very well, but at the cost of reduced efficiency and may not be practical since a Zener diode is not well adapted to dissipate a large amount of energy.

The theoretical transfer ratios Vₒᵤₜ/Vᵢₙ of the rail-to-tap and output-to-tap converter topologies were verified by series of practical measurements. FIG. 15 shows the transfer ratio test results for the Watkins-Johnson converter topology illustrating that experimental results match the theoretical curves fairly well.

Growing customer requirements on safety and comfort, together with demands for utility options and supplemental facilities may cause a power network conversion from 14V to 42V in vehicle in the near future. Semiconductors requiring a power supply as low as 3V or even lower cannot contain a basic buck converter having an unacceptably low duty cycle across the main transistor switch. To extend the duty cycle of the main transistor switch, the invention permits substitute for the main coil of the classical buck converter by a using tapped-inductor arranged to form a Watkins-Johnson converter in an automotive electrical power supply system. Tapped-inductor converters exhibit some beneficial characteristics such as a variable output voltage by adjusting the winding ratio to a value at which the converter efficiency is improved. This extra-degree of freedom is simply achievable since the Watkins-Johnson converter only employs four components, an inductor, a diode, a switch and a capacitor, diminishing the weight, size, cost and complexity of a converter system.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for adapting buck converters to an automotive electrical supply system having a voltage source comprising:
arranging a tapped inductor to form a tapped inductor converter wherein said converter supplies an output voltage at about an order less than the voltage of said voltage source.

2. The invention as defined in claim 1 wherein said voltage source is a battery.

3. The invention as defined in claim 2 wherein said battery is a 42 volt rated battery.

4. The invention as defined in claim 3 wherein said output voltage not greater than 5 volts.

5. The invention as defined in claim 4 wherein said output voltage is 3.3 volts.

6. The invention as defined in claim 1 wherein said arranging includes adding a snubber.

7. The invention as defined in claim 6 wherein said snubber is an RC snubber.

8. The invention as defined in claim 6 wherein said snubber is an LC snubber.

9. The invention as defined in claim 1 wherein said arranging includes adding a shield.

10. A step down voltage converter for an automotive electrical power supply network having a voltage source, comprising:
a tapped inductor arranged to form the converter with a switch and having at least one output voltage at a level about one order less than the voltage of the voltage source.

11. The invention as defined in claim 10 and further comprising a snubber.

12. The invention as defined in claim 10 wherein said tapped inductor has a tap at half the inductor coil length.

13. The invention as defined in claim 11 wherein said snubber comprises an RC snubber.

14. The invention as defined in claim 10 and further comprising a shield.

15. An automotive electrical power supply network comprising:
a voltage source having an input voltage capacity of at least 40 volts,
a plurality of outputs having at least one output regulated at less than one-tenth of said input voltage, and
a converter comprising a tapped inductor, a switch controlling said at least one output, a capacitor for regulating said at least one output, and a diode for limiting polarity of said at least one output.
